(19) United States
(12) Patent Application Publication
(10) Pub. No.: US 2024/0119043 A1
(43) Pub. Date: Apr. 11, 2024

(54) DATABASE SYSTEMS AND METHODS OF USING TIERED RECORDS FOR AUDITABILITY OF ASYNCHRONOUS RELATED EVENTS

(71) Applicant: Salesforce, Inc., San Francisco, CA (US)

(72) Inventors: Parvin Panesar, Renton, WA (US); Prabhjot Singh, Union City, CA (US); Ramakrishna Vankayalapati, Milpitas, CA (US); Parool Mody, Sunnyvale, CA (US)

(73) Assignee: Salesforce, Inc., San Francisco, CA (US)

(21) Appl. No.: 17/938,842

(22) Filed: Oct. 7, 2022

(51) Int. Cl. G06F 16/23; G06F 16/26; G06F 16/27; G06Q 30/04

(52) U.S. Cl. CPC G06F 16/2379; G06F 16/26; G06F 16/273; G06Q 30/04

(57) ABSTRACT

Database systems and methods are provided for managing related records using a tiered hierarchical arrangement that supports asynchronous and independent events with respect to related records. A method involves automatically generating a child record having a field value based on configuration data associated with a parent record, automatically updating a second field value for a summarization field associated with the parent record in response to automatically generating the child record, and after automatically updating the second field value, identifying a group record that is a parent of the parent record based on a second field of the parent record, automatically updating a third value for a second summarization field associated with the group record based at least in part on the second field value, and providing a graphical representation of the group record including a graphical representation of the third value for the second summarization field.

### TECHNICAL FIELD

One or more implementations relate to the field of database systems, and more specifically, to managing related records at a database system using a tiered arrangement that supports auditability of asynchronous events.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In a CRM setting or other business context, subscription-based products or services are often utilized to build customers and provide predictable growth and income streams. However, during the course of a subscription, a customer may desire to make various changes (e.g., changes to quantity, price, subscription duration, subscription type, etc.) to a subscription as a result of upselling, downselling, renewals, suspensions or resumptions, cancellations, and the like. Such changes to an existing subscription may also require corresponding changes to billing, invoicing, collections, or other aspects related to the product or service. However, to ensure auditability and accurate accounting, existing subscription management services can be inflexible and limit the ability of a particular product or service provider to accommodate a customer's preferences with respect to his or her subscriptions by making changes during the lifecycle of an existing subscription. Accordingly, it is desirable to provide a flexible service capable of accommodating various customizations and changes to subscriptions while maintaining accounting and auditability of those subscriptions.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that supports a tiered hierarchical arrangement of records according to some example implementations;

FIG. 2 is a block diagram illustrating a tiered hierarchical arrangement of records suitable for use in the computing system of FIG. 1 according to some example implementations;

FIG. 3 is a flow diagram illustrating a record management process suitable for implementation in connection with the tiered hierarchical arrangement of records of FIG. 2 in the computing system of FIG. 1 according to some example implementations;

FIGS. 4-9 depict an exemplary sequence of graphical user interface (GUI) displays suitable for presentation on a client device in connection with the record management process of FIG. 3 according to an example implementation;

FIG. 10A is a block diagram illustrating an electronic device according to some example implementations; and

FIG. 10B is a block diagram of a deployment environment according to some example implementations.

### DETAILED DESCRIPTION

The following description describes implementations for enabling flexible, customizable and user-configurable subscriptions that allow for different types of changes, amendments or configurations while preserving accounting, auditability and automation. As described in greater detail below, a three-tiered hierarchical arrangement of records is implemented or otherwise maintained at a database system, where an intermediate (or tier 2) record is created for each order or amendment to a particular subscription for a particular asset (e.g., a subscription-based product or service), where the intermediate record maintains configuration data associated with the respective order or amendment. A service associated with the database system utilizes the configuration data to automatically generate one or more lower level (or tier 3) records having a child relationship to the parent intermediate record having particular field values and at a particular point in time in accordance with the configuration data. The service also creates a top level group (or tier 1) record associated with a particular customer or account that has a parent relationship to the different child intermediate (or tier 2) records corresponding to the different orders or amendments associated with a particular combination of that particular customer or account and corresponding subscription-based asset that is subject to the respective order or amendment.

As described in greater detail below, when a lower level (tier 3) record is automatically generated with one or more field values based on the configuration data associated with its parent intermediate (or tier 2) record at a particular time according to the configuration data, the value(s) for one or more summarization fields of the intermediate record are automatically updated to reflect the generation of the lower level record in response to creation of the lower level record. After updating the summarization field value(s) of the intermediate record, the service at the database system automatically identifies the group (tier 1) record that is a parent of the updated intermediate record and automatically updates the value(s) for one or more summarization fields of the group record based on the updated summarization field value(s) of the intermediate record. Thus, a user may view or analyze the group record to obtain a summary of related records that may be asynchronously generated, at different points in time, in accordance with different configurations (e.g., based on the configuration data associated with the respective intermediate records). For example, an application platform at the database system may provide a graphical representation of the group record that includes graphical representations of the up-to-date value(s) for the summarization field(s) of the group record. A group record graphical user interface (GUI) display provided by the application platform within an instance of a virtual application presented at a client device may include hyperlinks or other selectable GUI elements that allow a user to select a particular child intermediate record associated with the group record to similarly view or analyze the updated summarization field value(s) associated with the selected child intermediate record and similarly select a particular lower level (tier 3) child record of the intermediate record to view details associated with the particular lower level child record.

For example, in a billing context, a billing service at a database system automatically creates an intermediate (tier 2) billing schedule record for each order that maintains billing configuration data associated with the respective order. In this regard, the billing configuration data may define the price, quantity, term, billing period or frequency, and other criteria that dictate when and how the customer is to be billed in association with that particular order, which may be independent of and asynchronous with respect to other related orders (e.g., existing subscriptions, add-ons or other amendments) for the same customer or account. In response to creation of a billing schedule record, the billing service may also automatically create or update an existing top level (tier 1) billing schedule group record to maintain an association between the different related orders for the same asset for the same customer or account. The billing service utilizes the billing configuration data associated with the billing schedule record to automatically and asynchronously generate child (tier 3) billing period transaction records at the appropriate time and frequency for the particular quantities and amounts specified by the billing configuration data. In response to generating a billing period transaction record, the billing service automatically updates fields of the parent billing schedule record that summarize the child billing period transaction records associated with the billing schedule record, for example, by updating the total amount billed associated with that parent billing schedule record.

After updating the total amount billed and/or other summarization field value(s) of the billing schedule record, the billing service automatically updates the fields of the parent billing group record that summarize the child billing schedule records associated with the billing group record, for example, by updating the total amount billed across all of the related child billing schedule records. In this regard, a user may utilize the billing group record to review, analyze or otherwise identify the total amount billed to a particular customer or account across their various orders, drill down into the individual billing schedule records to review, analyze or otherwise identify the total amount billed with respect to a particular order, and drill down into the individual billing period transaction records for a particular order. In this manner, the tiered hierarchical arrangement allows for accounting and auditability across different related orders, individually or in combination, while also at billing schedule and billing period transaction records, while also allowing the billing schedules and corresponding billing periods to be generated independently and asynchronously with respect to one another, thereby accommodating a wide variety of potential changes or amendments to an existing subscription.

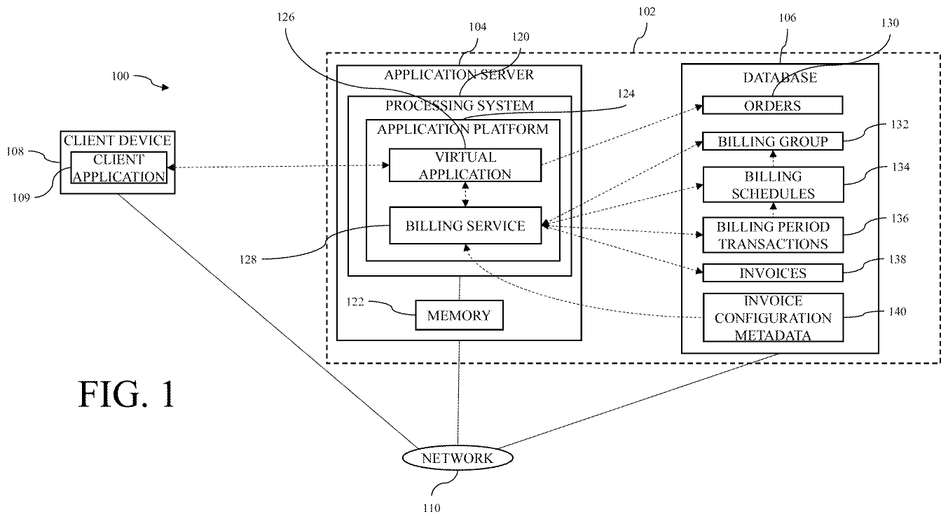

FIG. 1 depicts an exemplary computing system 100 capable of supporting auditability and accounting of asynchronous related events using a tiered hierarchical arrangement of records maintained at a database system 102. It should be appreciated that FIG. 1 is a simplified representation of a computing system 100 and is not intended to be limiting. In the illustrated implementation, the database system 102 includes one or more servers 104 that users of client devices 108 may interact with, over a communications network 110 (e.g., the Internet or any sort or combination of wired and/or wireless computer network, a cellular network, a mobile broadband network, a radio network, or the like), to view, access or obtain data or other information from one or more data records at a database 106 or other repository associated with the database system 102.

In one or more exemplary implementations, the database system 102 includes one or more application servers 104 that support an application platform 124 capable of providing instances of virtual applications 126, over the network 110, to any number of client devices 108 that users may interact with to obtain data or other information from one or more data records 114 maintained in one or more data tables 112 at the database 106 associated with the database system 102. For example, the database 106 may maintain, on behalf of a user, tenant, organization or other resource owner, data records entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the database 106). In this regard, in one or more implementations, the database system 102 is realized as an on-demand multi-tenant database system that is capable of dynamically creating and supporting virtual applications 126 based upon data from a common resource database 106 that is shared between multiple tenants, which may alternatively be referred to herein as a multi-tenant database. Data and services generated by the virtual applications 126 may be provided via the network 110 to any number of client devices, as desired, where instances of the virtual application may be suitably generated at run-time (or on-demand) using a common application platform 124 that securely provides access to the data in the database 106 for each of the various tenants subscribing to the multi-tenant system.

The application server 104 generally represents the one or more server computing devices, server computing systems or other combination of processing logic, circuitry, hardware, and/or other components configured to support remote access to data records maintained in the data tables at the database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receiver, transceivers, wired network interface controllers (e.g., an Ethernet adapter), wireless adapters or another suitable network interface that supports communications to/from the network 110 coupled thereto. The application server 104 also includes or otherwise accesses a data storage element 122 (or memory), and depending on the implementation, the memory 122 may be realized as a random-access memory (RAM), read only memory (ROM), flash memory, magnetic or optical mass storage, or any other suitable non-transitory short- or long-term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and the subject matter described herein.

The client device 108 generally represents an electronic device coupled to the network 110 that may be utilized by a user to access an instance of the virtual application 126 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 126. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. The illustrated client device 108 executes or otherwise supports a client application 109 that communicates with the application platform 124 provided by the processing system 120 at the application server 104 to access an instance of the virtual application 126 using a networking protocol. In some implementations, the client application 109 is realized as a web browser or similar local client application executed by the client device 108 that contacts the application platform 124 at the application server 104 using a networking protocol, such as the hypertext transport protocol (HTTP). In this manner, in one or more implementations, the client application 109 may be utilized to access or otherwise initiate an instance of a virtual application 126 hosted by the database system 102, where the virtual application 126 provides one or more web page GUI displays within the client application 109 that include GUI elements for interfacing and/or interacting with records 114 maintained at the database 106.

In exemplary embodiments, the database 106 stores or otherwise maintains data for integration with or invocation by a virtual application 126 in objects organized in object tables. In this regard, the database 106 may include any number of different object tables configured to store or otherwise maintain alphanumeric values or other descriptive information that define a particular instance of a respective type of object associated with a respective object table. For example, the virtual application may support a number of different types of objects that may be incorporated into or otherwise depicted or manipulated by the virtual application, with each different type of object having a corresponding object table that includes columns or fields corresponding to the different parameters or criteria that define a particular instance of that object. In some implementations, the database 106 stores or otherwise maintains application objects (e.g., an application object type) where the application object table includes columns or fields corresponding to the different parameters or criteria that define a particular virtual application 126 capable of being generated or otherwise provided by the application platform 124 on a client device 108. In this regard, the database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that application 126.

In exemplary implementations, the database 106 stores or otherwise maintains additional database objects for association and/or integration with a virtual application 126, which may include custom objects and/or standard objects. For example, an administrator user associated with a particular resource owner may utilize an instance of a virtual application 126 to create or otherwise define a new custom field to be added to or associated with a standard object, or define a new custom object type that includes one or more new custom fields associated therewith. In this regard, the database 106 may also store or otherwise maintain metadata that defines or describes the fields, process flows, workflows, formulas, business logic, structure and other database components or constructs that may be associated with a particular application database object. In various implementations, the database 106 may also store or otherwise maintain validation rules providing validation criteria for one or more fields (or columns) of a particular database object type, such as, minimum and/or maximum values for a particular field, a range of allowable values for the particular field, a set of allowable values for a particular field, or the like, along with workflow rules or logical criteria associated with respective types of database object types that define actions, triggers, or other logical criteria or operations that may be performed or otherwise applied to entries in the various database object tables (e.g., in response to creation, changes, or updates to a record in an object table).

For example, as described in greater detail below, in exemplary implementations, the database 106 stores or otherwise maintains an order database object table that includes entries corresponding to different order database records 130 associated with a particular resource owner. In this regard, an entry for an order record 130 maintains user-configurable values or criteria associated with that particular order, such as, for example, a quantity or number of units associated with the particular order, a name or other identifier associated with the product or asset that is the subject of the order, the unit price associated with the order, the total price associated with the order, the start date and/or end date for the particular order, and identifiers or references to any original or parent order to be associated with the respective order. For example, in some implementations, the order database records 130 may include a parent order record that maintains an association with a particular account or customer to be billed along with other higher level order configuration data (e.g., order start date, contract end date, order amount total, order end data, order name or other identifiers, order type, etc.) along with one or more child order product records associated with the parent order record that maintain the order details for a particular product or service (e.g., a quantity or number of units, a name or other identifier associated with the product or asset, the unit price, the total price, the start date and/or end date, etc.) that are associated with the different distinct order-related events associated with the parent order record. For example, a first child order product database record may maintain order details associated with an original or initial order or subscription for a particular product or service to be associated with a particular parent order record, while additional child order product database records may maintain order details associated with additions, reductions or other changes or amendments to the original or initial order related to that same parent order record.

In exemplary implementations, an instance of a virtual application 126 may provide, within the client application 109, one more GUI displays including one or more GUI elements manipulable by a user of the client device 108 to input the order details or other order criteria and create or otherwise define one or more new order records 130 to be supported for a customer of a particular resource owner. After defining the criteria to be associated with the respective order, the virtual application 126 creates one or more corresponding entries in the database 106 to maintain the corresponding order record(s) 130 for that particular order, subscription or amendment thereto.

In exemplary implementations, the application platform 124 includes or otherwise supports a billing service 128 that is configurable to utilize the user-configured order criteria from the different related order records 130 associated with a particular resource owner to generate corresponding sets of billing records 132, 134, 136 that support automations, reports or other functionality at the database system 102 while providing accurate accounting and auditability. As described in greater detail below, for each order record 130, the billing service 128 may automatically generate a billing schedule record 134 associated with the particular order record 130 using values from one or more fields of data associated with the order record 130 to support automatically generating corresponding billing period transaction records 136 for invoicing the respective order in accordance with the order configuration data defined for that order record 130. Additionally, the billing service 128 assigns each billing schedule record 134 to a billing group record 132 that maintains an association between different related billing schedule records 134 that are associated with a common combination of customer or account and the product, service or asset that is subject of the related billing schedule records 134 and corresponding order records 130. In this regard, the billing schedule records 134 and billing period transaction records 136 generated by the billing service 128 allow for the different related orders to be billed asynchronously and/or independently from one another, while also allowing the billing service 128 to automatically generate corresponding invoice records 138 in the database 106 to automatically invoice the customer of the particular resource owner in a configurable and customizable manner in accordance with invoice configuration metadata 140 maintained in the database 106. The billing service 128 utilizes the invoice configuration metadata 140 and one or more of the billing records 132, 134, 136 to automatically generate invoice records 138 corresponding to the invoices to be provided to customers of the resource owner.

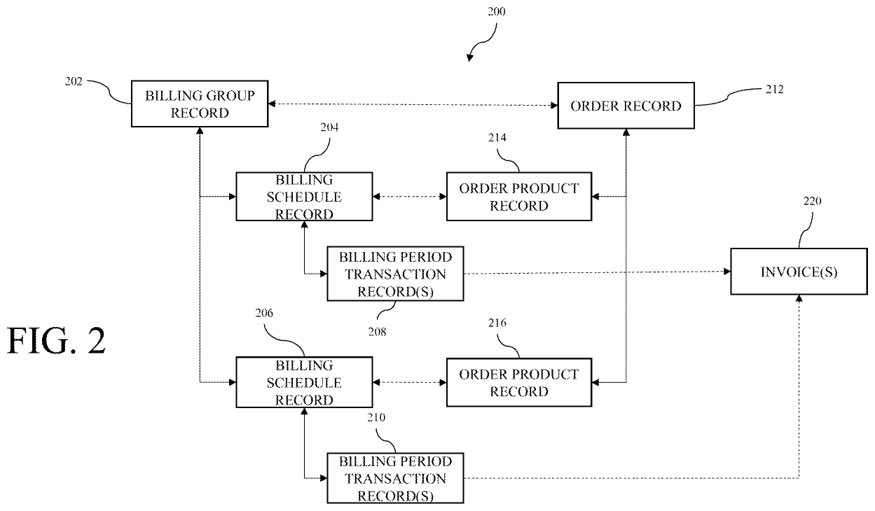

FIG. 2 depicts an exemplary tiered hierarchical arrangement 200 of database records suitable for implementation at the database 106 of the database system 102 in connection with the billing service 128. For example, after a user interacts with an instance of a virtual application 126 provided within the client application 109 at the client device 108 to input order details or other order criteria, a corresponding order record 212 (e.g., one of order records 130) may be created that includes data fields maintaining the association between the order and the particular account or customer along with other order configuration data (e.g., order start date, contract end date, order amount total, order end data, order name or other identifiers, order type, etc.). Additionally, a child order product record 214 (e.g., another one of the order records 130) associated with the order record 212 is created that includes data fields maintaining the order details for the particular product or service associated with the order record 212 (e.g., the name or other identifier associated with the product or asset, the quantity or number of units, the unit price, the total price, the start date and/or end date, etc.). In response to creation of the order records 212, 214, the billing service 128 automatically creates and/or configures corresponding billing records 202, 204 associated with the order records 212, 214 in the database 106. For example, in response to creation of the order record 212, the billing service 128 may automatically create a corresponding billing group record 202 (e.g., billing group record 132) associated with the order record 212, where one or more fields of the billing group record 202 are populated using values or data from the fields of the order record 212, for example, to identify the order start date, contract end date, the order type, and/or the like.

Additionally, in response to creation of the order product record 214, the billing service 128 automatically creates a corresponding billing schedule record 204 (e.g., billing schedule record 134) associated with the order product record 214 and having a child relationship to the parent billing group record 202 associated with the order record 212. One or more fields of the billing schedule record 204 are populated using values or data from the fields of the order product record 214 that identify or otherwise indicate the billing configuration for the order, for example, to identify the period or frequency at which the customer is to be billed in connection with the order product record 214, the quantity or number of units associated with the order product record 214, the unit price associated with the order product record 214 and/or the like.

After creating the billing schedule record 204, the billing service 128 utilizes the values for the fields of order configuration data associated with the billing schedule record 204 to automatically determine when a customer is supposed to be billed for the respective order in accordance with the respective billing configuration data defined for the order product record 214, and in response to determining that the customer should be billed, the billing service 128 automatically creates a corresponding billing period transaction record 208 (e.g., billing period transaction record 136) having a child relationship to the billing schedule record 204 to facilitate billing the customer or account in accordance with the billing schedule record 204. For example, when the billing configuration data defined for the order product record 214 indicates that the customer should be billed monthly, the billing service 128 may automatically generate a corresponding billing period transaction record 208 on a monthly basis for an amount equal to the product of the unit price associated with the billing schedule record 204 and the quantity of units associated with the billing schedule record 204. Thereafter, the billing service 128 may utilize the billing period transaction record 208 in conjunction with the invoice configuration metadata 140 to automatically generate a corresponding invoice record 220 (e.g., invoice record 138). In this regard, the invoice configuration metadata 140 allows an administrator or other user associated with a particular resource owner to customize automation of invoicing, for example, by invoicing different order products together or separately, at a particular point in time within a billing period, with different splits or invoice lines to display, for example, the list of purchased products or services, the total amount owed or paid by the customer, the balance, the due date, the payment status, and the like.

As described in greater detail below, the tiered hierarchical arrangement 200 of the billing records 202, 204, 208 allows for amendments or changes to the initial or original order corresponding to the order record 212 to be billed asynchronously and independently of the initial or original billing schedule, while maintaining accounting and auditability across all the different billing schedules associated with the billing group record 202. For example, after a user may interact with an instance of a virtual application 126 to place an additional order to related to the original order record 212, for example, to increase the quantity or number of units of a particular product, service or asset, over a different term or timeline associated with the original order, at a different unit price relative to the original order, or alternatively, to place a reduction order to reduce the quantity, term, unit price and/or the like. In response to receiving order configuration data from a user relating to an existing order record 212 (e.g., by virtue of being associated with the same customer or account), the virtual application 126 and/or the application platform 124 automatically creates another child order product record 216 associated with the original order record 212 that includes data fields populated with values that reflect the amendments or adjustments associated with the original order record 212, for example, by identifying the name or other identifier associated with the product or asset associated with the amendment, the quantity or number of units associated with the amendment, the unit price associated with the amendment, and/or the like.

In response to creation of another order product record 216, the billing service 128 automatically creates a corresponding billing schedule record 206 associated with the order product record 216 and having a child relationship to the parent billing group record 202 associated with the original order record 212. Similar to the original billing schedule record 204, the fields of the sibling billing schedule record 206 are similarly populated using values or data from the fields of the order product record 216 that identify or otherwise indicate the billing configuration for the amendment to the existing order, for example, to identify the period or frequency at which the customer is to be billed in connection with the order product record 216, the quantity or number of units associated with the order product record 216, the unit price associated with the order product record 216 and/or the like. In this regard, the fields of the billing schedule record 206 are populated with billing configuration data from the order product record 216 that is independent of the billing configuration data associated with the original billing schedule record 204 and the original order product record 214. Thus, the billing service 128 may utilize the values for the fields of billing configuration data associated with the billing schedule record 206 to automatically create corresponding billing period transaction records 210 to bill the customer or account in association with the order product record 216 asynchronously and independently from the billing period transaction records 208 for the original order product record 214. In this regard, amendments to an existing order record 212 may be billed with different timing, as well as for different quantities and/or terms, relative to the original order product record 214, thereby allowing for flexible and customizable amendments to an existing order.

In a similar manner as the original billing period transaction records 208, the billing service 128 may utilize the billing period transaction records 210 in conjunction with the invoice configuration metadata 140 to automatically generate corresponding invoice records 220. In this regard, the invoice configuration metadata 140 allows for one or more billing period transaction records 208 associated with the original order product record 214 to be combined with one or more billing period transaction records 210 associated with a subsequent order product record 216 associated with an amendment to the original order (e.g., by causing the billing service 128 to generate an invoice record 220 that combines different billing period transaction records 208, 210), or alternatively, allowing invoice records 220 to be separately generated for the original order product record 214 and any subsequent order product record(s) 216. That said, by virtue of the parent-child relationship between the billing schedule records 204, 206 and the billing period transaction records 208, 210 along with the parent-child relationship between the billing group record 202 and the billing schedule records 204, 206, the tiered hierarchical arrangement 200 allows for accounting of the total amount billed in association with a particular order record 212 across different billing schedule records 204, 206, while also allowing for the accounting of the total amount billed with respect to each order product record 214, 216 separately, with the billing period transaction records 208, 210 providing auditability and supporting accounting to ensure billing in accordance with the billing configuration data defined upon creation of the different order product records 214, 216.

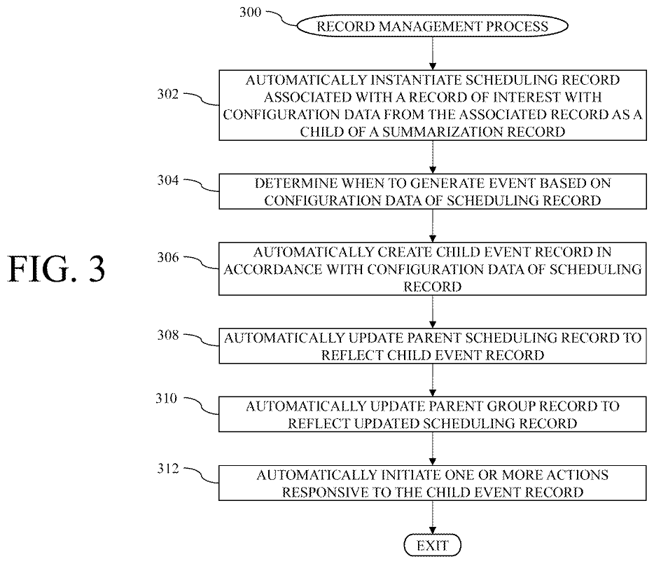

FIG. 3 depicts an exemplary record management process 300 suitable for implementation by a service supported by an application platform at a database system, such as the billing service 128 at the database system 102, to automatically create and update fields of related records maintained at the database system and perform additional tasks, functions, and/or operations described herein. For illustrative purposes, the following description may refer to elements mentioned above in connection with FIG. 1. It should be appreciated that the record management process 300 may include any number of additional or alternative tasks, the tasks need not be performed in the illustrated order and/or the tasks may be performed concurrently, and/or the record management process 300 may be incorporated into a more comprehensive procedure or process having additional functionality not described in detail herein. Moreover, one or more of the tasks shown and described in the context of FIG. 3 could be omitted from a practical implementation of the record management process 300 as long as the intended overall functionality remains intact.

Referring to FIG. 3 with continued reference to FIGS. 1-2, in exemplary implementations, the record management process 300 is performed to automatically create or otherwise instantiate new child records based at least in part on configuration data associated with a parent record and provide corresponding updates to one or more fields of the parent record in response to creation or updating of a child record. In this regard, in exemplary implementations described herein, the record management process 300 is implemented or otherwise performed by the billing service 128 to automatically create or otherwise instantiate new child billing period transaction records based at least in part on billing configuration data associated with a parent billing schedule record, provide corresponding updates to one or more fields of the parent billing schedule record in response to creation of the child billing period transaction record, and correspondingly update one or more fields of the grandparent billing group record (e.g., the parent record of the updated billing schedule record) to reflect the updates to the one or more fields of the parent billing schedule record.

The record management process 300 initializes or otherwise begins by automatically instantiating or otherwise creating a scheduling record for one or more events to be associated with another record of interest with configuration data from that associated record in response to creation of that record and configuring the scheduling record as a child of a summarization record for summarizing events related to the scheduling record based on the associated record (task 302). In this regard, the configuration data provides the values or other criteria that dictate when events are expected to occur in accordance with the configuration data defined for the associated record. For example, in one or more exemplary implementations, in the context of a billing service 128 associated with a CRM virtual application 126, the billing service 128 automatically instantiates or otherwise creates a billing schedule record 206 for one or more billable events to be associated with an order product record 216 using values for one or more fields of billing configuration data from the order product record 216 to configure the billing schedule record 206 to automatically detect, identify or otherwise generate billable events in accordance with the billing configuration data defined for the order product record 216. The billing schedule record 206 is configured with one or more fields that identify or otherwise reference a parent billing group record 202 for summarizing billable events associated with a particular order record 212 that include billable events related to the billing schedule record 206. In this regard, in the case of an order product record 216 that represents an amendment or change to a subscription-based product, service or asset associated with an existing order record 212, the billing service 128 utilizes one or more fields of the associated order product record 216 to identify or otherwise determine the parent order record 212 associated with the order product record 216, and based on the parent order record 212, the billing service 128 identifies the corresponding billing group record 202 associated with the order record 212 for summarizing billable events related to the order record 212 and configures one or more fields of the billing schedule record 206 to reference the parent billing group record 202. That said, in situations where the order product record is a child of an order record for which a corresponding billing group record does not exist (e.g., original order product record 214 associated with the initial or original order record 212), the billing service 128 also automatically creates or otherwise instantiates the summarization billing group record to be associated with the new order record as a parent of the newly created billing schedule record (e.g., by creating billing group record 202 as the parent of the original billing schedule record 204 in response to creation of the billing schedule record 204).

After creating the scheduling record, the record management process 300 continues by automatically determining or identifying when to generate an event associated with the database record of interest based on the configuration data associated with the scheduling record and automatically creating or otherwise instantiating an event record as a child of the scheduling record in accordance with the configuration data of the scheduling record in response to determining the event should occur (tasks 304, 306). For example, continuing the example of a billing schedule record 206 in the context of a billing service 128 associated with a CRM virtual application 126, the billing service 128 automatically analyzes or otherwise monitors the billing configuration data associated with the billing schedule record 206 to determine when one or more billable event criteria are satisfied. In response to determining that the billable event criteria associated with the billing schedule record 206 are satisfied, the billing service 128 automatically instantiates or otherwise creates a child billing period transaction record 210 corresponding to the billable event using the billing configuration data associated with the billing schedule record 206. For example, if the billing configuration data associated with the billing schedule record 206 indicates that a billable event should occur on a monthly basis on a particular day of the month (e.g., based on the start date), the billing service 128 automatically determines a billing event should be generated on that particular day of the month and creates a corresponding child billing period transaction record 210 for a billable event having a total billed amount corresponding to the unit price per month and quantity per month defined by the billing schedule record 206.

After creating a child event record, the record management process 300 automatically updates the parent scheduling record to reflect the child event record and then automatically updates the group record that is a parent of the parent scheduling record to reflect the updated scheduling record (tasks 308, 310). For example, continuing the example of a billing schedule record 206 in the context of a billing service 128 associated with a CRM virtual application 126, the billing service 128 automatically updates a total billed amount associated with the billing schedule record 206 to reflect the total billed amount associated with the child billing period transaction record 210, for example, by incrementing the value for the total billed amount field associated with the billing schedule record 206 by an amount equal to the total billed amount associated with the child billing period transaction record 210 (e.g., the product of the unit price and quantity of units). After updating the total billed amount associated with the billing schedule record 206, the billing service 128 automatically updates a total billed amount associated with the billing group record 202 to reflect the updated total billed amount associated with the billing schedule record 206, for example, by incrementing the value of the total billed amount field associated with the billing group record 202 to reflect the increase to the total billed amount field associated with the billing schedule record 206 or adding the updated value of the total billed amount field associated with the billing schedule record 206 to the current value of the total billed amount field associated with the sibling billing schedule record 204. In this regard, the billable event corresponding to the child billing period transaction record 210 is reflected by both the billing group record 202 and the billing schedule record 206 by propagating updates from the billing period transaction record 210 to its parent billing schedule record 206 and from its parent billing schedule record 206 to its parent billing group record 202.

Still referring to FIG. 3, in exemplary implementations, the record management process 300 automatically initiates or otherwise performs one or more actions at a database system responsive to creation of the child event record and updating the related parent records (task 312). For example, in one or more implementations, the billing service 128 utilizes the billing period transaction record 210 and the invoice configuration metadata 140 associated with the particular resource owner, the customer or account and/or the parent order record 212 to automatically generate an invoice record 220 that includes, incorporates or otherwise reflects the billing period transaction record 210. In this regard, depending on the invoice configuration metadata 140, the generated invoice record 220 may include, incorporate or otherwise utilize values from one or more fields of the billing period transaction record 210, either individually or in combination with values from one or more fields of other billing period transaction records 208, 210, to provide a corresponding invoice to the customer or account having the desired line items, split levels, and/or the like. Additionally, or alternatively, in some implementations, the billing service 128 utilizes the updated values for the fields of the billing group record 202 and/or the billing schedule record 206 to automatically generate one or more reports that reflect the billable event or otherwise update one or more GUI displays to account for the billable event and the corresponding updates to the billing group record 202 and/or the billing schedule record 206.

It should be noted that the tiered hierarchical arrangement of related records in concert with the record management process 300 supports automated generation of asynchronous individual billable events as well as timeline based billing events while also accommodating asynchronous adjustments to existing orders or subscriptions, such as, for example, quantity amendments, price adjustments, suspension and/or resumption of services, renewals, cancellations and the like. In this regard, the billing schedule records and child billing period transaction records can be utilized to change billing strategies during the lifecycle of an existing order or subscription, thereby allowing user to interchange billing strategies (e.g., termed subscription, evergreen subscription, one-time purchases, backdated or future dated purchases, and/or the like) while maintaining accounting and auditability by virtue of the billing period transaction records tracking billable events while updating the parent billing schedule and group records to cumulatively account for the billable events.

For example, for every billable change to an order record or order product record, a corresponding billing schedule record is created that resides at the intermediate tier of the tiered hierarchical arrangement and maintains billing configuration data containing billable changes to the existing order. Based on that billing configuration data, lower tier child billing period transaction records that maintain the billing data for auditing billable events associated with that billing schedule record are created in an automated manner and utilized for subsequent automated conversion into corresponding invoice lines using invoice configuration metadata. The amount billed or other billing data associated with the child billing period transaction records is deducted from the parent billing schedule record or otherwise reflected by updates to the parent billing schedule record. Updates to the parent billing schedule record are also propagated up to its parent billing group record, which summarizes all the billable events and billing changes across the related billing schedules associated with a common order record to provide a holistic overview of the billable events associated with that order record, thereby reducing reporting overhead. The tiered hierarchical arrangement provides flexibility that allows for billable events to be billed separately and in any order desired by a user. For example, a billing schedule record may be created for a renewal order product record that allows for the renewal to be billed and invoiced individually while maintaining the payment structure, billing, invoicing and/or the like associated with the original order intact or unchanged, thereby allowing renewal order revenue to be captured earlier and independently from the original order. Additionally, invoicing may be driven from the intermediate tier, thereby allowing billable events to be billed and invoiced individually or grouped together across different billing schedules, asynchronously or based on a timeline, and in any order desired by the customer. In one or more implementations, the tiered hierarchical arrangement is configurable such that all primary key (PK) chunking and batching is performed at the intermediate tier (e.g., the billing schedule records) rather than the top tier. For example, since the billing group record could have a one to many relationship with any number of different child billing schedule records, database queries may execute faster and more efficiently by loading billable event details from lower tier records rather than billing configuration data since the billing group record will already be in hot cache when fetched for a particular billing period transaction record. Moreover, the tiered hierarchical arrangement allows for lower level records to be archived to reduce costs and storage requirements while preserving relevant cumulative billing data in an active top tier billing group record (e.g., for reports, accounting, or other analytical purposes).

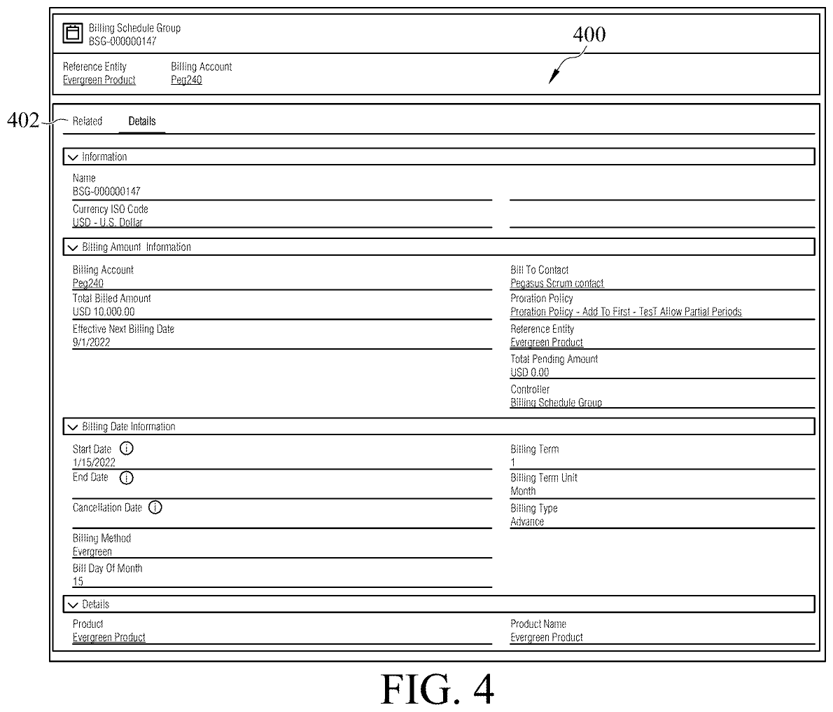

FIGS. 4-9 depict an exemplary sequence of web page GUI displays that may be generated or otherwise presented by an instance of a virtual application 126 within a client application 109 at a client device 108 in connection with an exemplary implementation of the record management process 300 of FIG. 3. In this regard, FIG. 4 depicts an exemplary billing group GUI display 400 that depicts a graphical representation of a billing group record 202 that includes graphical representations of the current values associated with various data fields of the billing group record 202 that were automatically populated upon creation of the billing group record 202 using billing configuration data maintained by the corresponding original order record 212 and/or original order product record 214 including, for example, the start date associated with the original order record (Jan. 15, 2022), the billing method associated with the original order (Evergreen), the billing period or term unit associated with the billing method (Monthly), the billing type (Advance), the billing day of the month (15). The billing group GUI display 400 also includes a graphical representation of the total billed amount field ($10,000) that is automatically updated by the billing service 128 based on the child billing schedule records 204, 206 associated with the billing group record 202 in accordance with the record management process 300, as described in greater detail below.

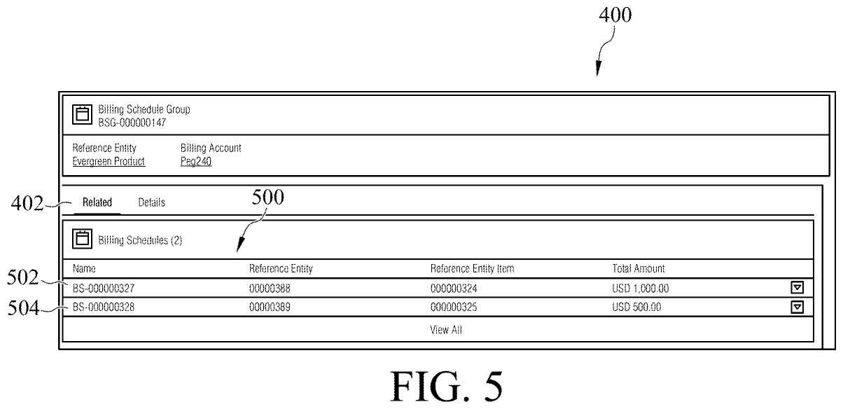

Referring to FIG. 5 with continued reference to FIGS. 1-4, in exemplary implementations, the billing group GUI display 400 includes a tabbed user interface having a tab, hyperlink or similar selectable GUI element 402 to dynamically update the billing group GUI display 400 to depict a list 500 of the child billing schedule records 204, 206 associated with the displayed parent billing group record 202. In this regard, FIG. 5 depicts an updated state of the billing group GUI display 400 after selection of the related tab 402 to view a list 500 of graphical indicia 502, 504 corresponding to the child billing schedule records 204, 206 related to the billing group record 202. In exemplary implementations, the graphical indicia 502, 504 of the child billing schedule records 204, 206 are realized as hyperlinks or similar selectable GUI elements that are selectable by a user to navigate from the billing group GUI display 400 to a billing schedule GUI display 600, 800, as described in greater detail below. Still referring to FIG. 5, the billing group GUI display 400 includes graphical representations of the defined values for the billing period amount fields of the child billing schedule records 204, 206 that represent the amount billed per billable event defined by the billing configuration data for the respective child billing schedule records 204, 206. In this regard, FIG. 5 depicts a scenario where the original billing schedule record 204 has a billing period amount of $1000 and the amendment billing schedule record 206 has a different billing period amount of $500.

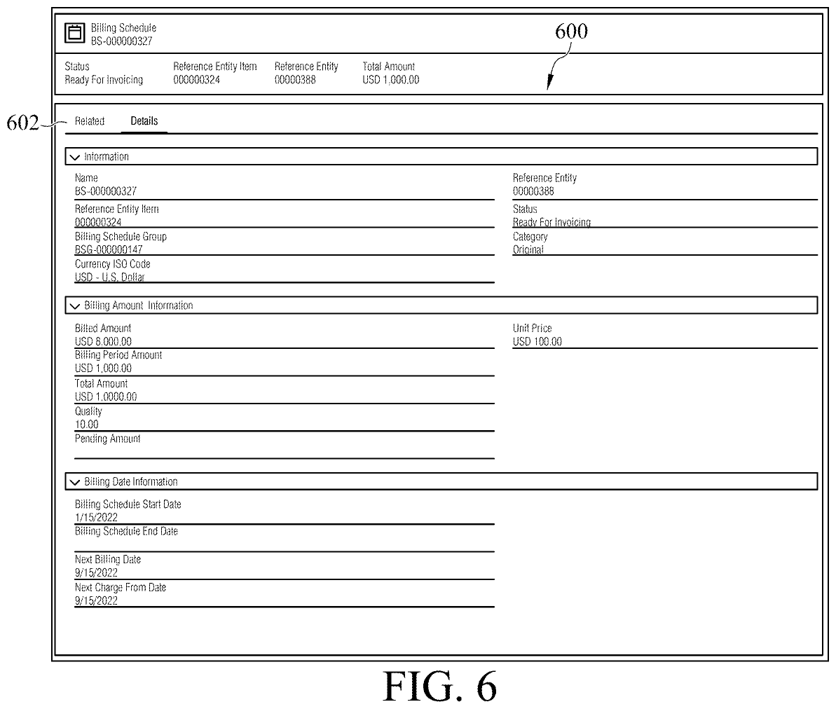

Referring to FIG. 6, with continued reference to FIGS. 1-5, in response to user selection of the GUI element 502 associated with the original billing schedule record 204, the virtual application 126 generates or otherwise provides a billing schedule GUI display 600 that depicts a graphical representation of original billing schedule record 204 that includes graphical representations of the current values associated with various data fields of the billing schedule record 204 that were automatically populated upon creation of the billing schedule record 204 using billing configuration data maintained by the corresponding original order record 212 and/or original order product record 214 including, for example, the start date associated with the billing schedule (Jan. 15, 2022), the quantity associated with the billing schedule (10 units), the unit price associated with the billing schedule ($100), the billing period amount corresponding to the product of the quantity and unit price associated with the billing schedule ($1000), and the like. The billing schedule GUI display 600 also includes a graphical representation of the total billed amount field ($8,000) that is automatically updated by the billing service 128 in accordance with the record management process 300 based on the child billing period transaction records 208 corresponding to the billable events associated with the billing schedule. In this regard, FIG. 6 depicts a state of the billing schedule GUI display 600 after eight different child billing period transaction records 208 for the billing period amount of $1000 have been previously generated by the billing service 128 resulting in the billing service 128 updating the value for the total billed amount field of the billing schedule record 204 to be equal to the cumulative billed amount associated with the child billing period transaction records 208 ($8000).

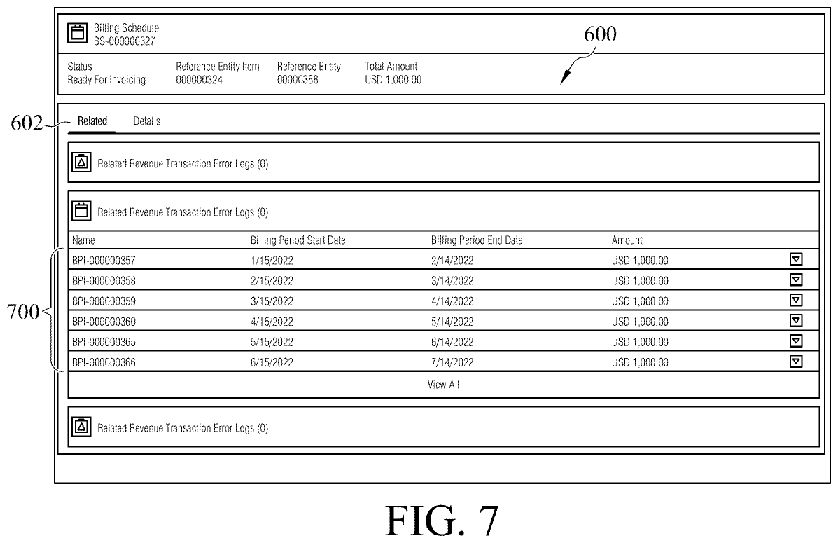

Referring to FIG. 7 with continued reference to FIGS. 1-6, similar to the billing group GUI display 400, in exemplary implementations, the billing schedule GUI display 600 includes tabbed user interface having a tab, hyperlink or similar selectable GUI element 602 to dynamically update the billing schedule GUI display 600 to depict a list 700 of the child billing period transaction records 208 associated with the displayed billing schedule record 204. In this regard, FIG. 7 depicts an updated state of the billing schedule GUI display 600 after selection of the related tab 602 to view the list 700 of graphical indicia corresponding to the billing period transaction records 208 having a child relationship to the original billing schedule record 204. In exemplary implementations, the graphical indicia of the child billing period transaction records 208 are realized as hyperlinks or similar selectable GUI elements associated with the identifiers assigned to the respective billing period transaction records 208 that are selectable by a user to navigate from the billing schedule GUI display 600 to audit or review the individual billing period transaction records 208 and corresponding billable events associated with the original billing schedule. As shown in FIG. 7, in exemplary implementations, the billing period transaction list 700 includes columns including the identifiers assigned to the respective billing period transaction records 208, the total billed amount associated with the respective billing period transaction record 208 (which equals the billing period amount associated with the parent billing schedule record 204) and the start date and/or end date that defines the respective billing period associated with the respective billing period transaction record 208.

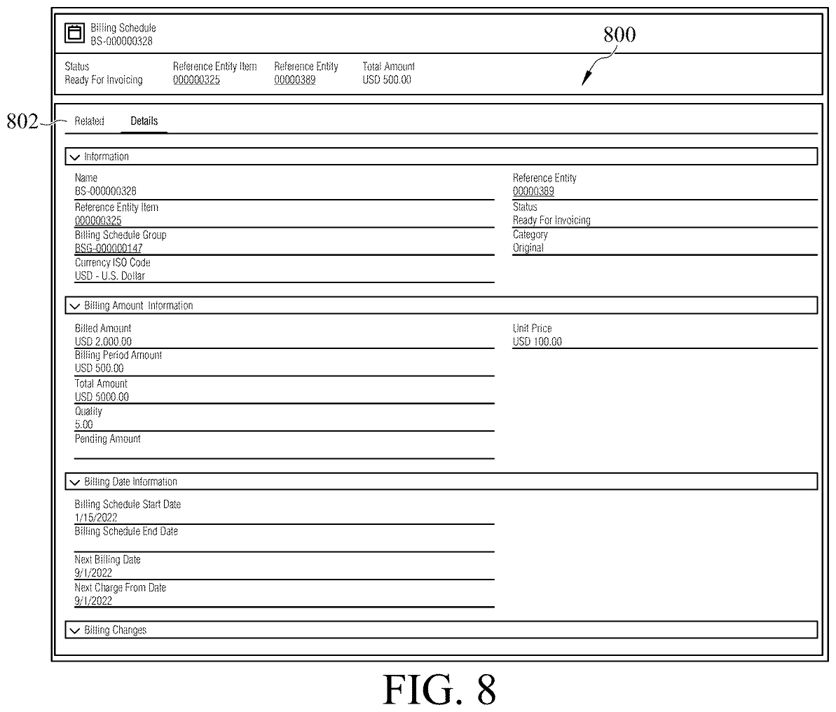

Referring to FIG. 8, with continued reference to FIGS. 1-5, in response to user selection of the GUI element 504 associated with the amendment billing schedule record 206, the virtual application 126 generates or otherwise provides a billing schedule GUI display 800 that depicts a graphical representation of amendment billing schedule record 206 that includes graphical representations of the current values associated with various data fields of the amendment billing schedule record 206 that were automatically populated upon creation of the billing schedule record 206 using billing configuration data maintained by the corresponding amendment order product record 216 including, for example, the start date associated with the amendment billing schedule (May 1, 2022), the quantity associated with the amendment billing schedule (5 units), the unit price associated with the amendment billing schedule ($100), the billing period amount corresponding to the product of the quantity and unit price associated with the amendment billing schedule ($500), and the like. In this regard, the defined values for one or more fields of the billing configuration data associated with the amendment billing schedule record 206 are different from the values defined for those one or more fields of the original billing schedule record 204. For example, the depicted amendment billing schedule results in a billable event being generated on a different day of the month, independent of the original billing schedule, and for a different quantity of units at a different billed amount. The billing schedule GUI display 800 also includes a graphical representation of the total billed amount field ($2,000) associated with the amendment billing schedule record 206, which is automatically updated by the billing service 128 in accordance with the record management process 300 based on the child billing period transaction records 210 corresponding to the billable events associated with the amendment billing schedule. In this regard, FIG. 8 depicts a state of the billing schedule GUI display 800 after four different child billing period transaction records 210 for the billing period amount of $500 have been previously generated by the billing service 128 resulting in the billing service 128 updating the value for the total billed amount field of the amendment billing schedule record 206 to be equal to the cumulative billed amount associated with the child billing period transaction records 210 ($2000).

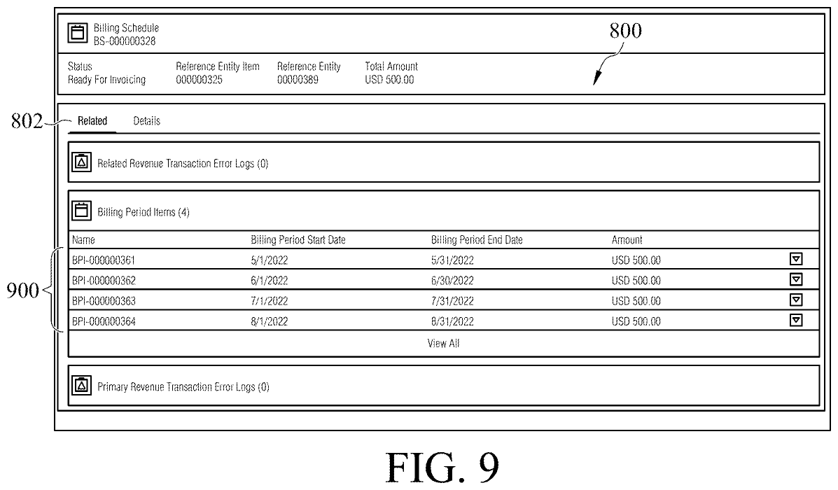

Referring to FIG. 9 with continued reference to FIGS. 1-8, as described above, the billing schedule GUI display 800 includes a tab, hyperlink or similar selectable GUI element 802 to dynamically update the billing schedule GUI display 800 to depict a list 900 of the child billing period transaction records 210 associated with the displayed billing schedule record 206. The graphical indicia of the child billing period transaction records 210 may be realized as hyperlinks or similar selectable GUI elements associated with the identifiers assigned to the respective billing period transaction records 210 that are selectable by a user to navigate from the billing schedule GUI display 800 to audit or review the individual billing period transaction records 210 and corresponding billable events associated with the amendment billing schedule. As shown in FIG. 9, in exemplary implementations, the billing period transaction list 900 includes columns including the identifiers assigned to the respective billing period transaction records 210, the total billed amount associated with the respective billing period transaction record 210 (which equals the billing period amount associated with the parent billing schedule record 206) and the start date and/or end date that defines the respective billing period associated with the respective billing period transaction record 210.

Referring to FIGS. 4-9 with continued reference to FIGS. 1-3, by virtue of the record management process 300, the value for the total billed amount field associated with the billing group record 202 that is depicted on the billing group GUI display 400 is automatically and asynchronously updated in response to updates to the total billed amount field of a respective child billing schedule record 204, 206, where the total billed amount field of that respective child billing schedule record 204, 206 is automatically and asynchronously updated in response to the billing service 128 detecting a billable event and generating a corresponding child billing period transaction record 208, 210 based on the billing configuration data associated with the respective child billing schedule record 204, 206. Continuing the example billing configurations depicted in FIGS. 4-9, on the first day of the next month (e.g., Sep. 1, 2022), the billing service 128 may automatically detect a billable event associated with the amendment billing schedule record 206 based on its associated billing configuration data and automatically create a corresponding child billing period transaction record 210 associated with the amendment billing schedule record 206 having a billing period start date of Sep. 1, 2022 and a total billed amount of $500 (e.g., tasks 304, 306). In response to generating the child billing period transaction record 210, the billing service 128 automatically updates the total billed amount of the parent amendment billing schedule record 206 by incrementing the current value of the total billed amount field ($2000) by the total billed amount associated with the new child billing period transaction record 210 ($500) to arrive at an updated total billed amount associated with the amendment billing schedule record 206 of $2500 (e.g., task 308). In response to updating the amendment billing schedule record 206, the billing service 128 automatically updates the total billed amount of the billing group record 202 to reflect the new billable event by adding the updated total billed amount value associated with the amendment billing schedule record 206 ($2500) to the total billed amount value associated with the original billing schedule record 204 ($8000) to obtain an updated total billed amount associated with the billing group record 202 of $10500 (e.g., task 310).

Thereafter, on the fifteenth day of the month (e.g., Sep. 15, 2022), the billing service 128 may automatically detect a billable event associated with the original billing schedule record 204 based on its associated billing configuration data and automatically create a corresponding child billing period transaction record 208 associated with the original billing schedule record 204 having a billing period start date of Sep. 15, 2022 and a total billed amount of $1000 (e.g., tasks 304, 306). In response to generating the child billing period transaction record 208, the billing service 128 automatically updates the total billed amount of the original amendment billing schedule record 204 (e.g., by incrementing the current value of the total billed amount field ($8000) by the total billed amount associated with the new child billing period transaction record 208 ($1000)) to arrive at an updated total billed amount associated with the original billing schedule record 204 of $9000 (e.g., task 308). In response to updating the original billing schedule record 204, the billing service 128 automatically updates the total billed amount of the billing group record 202 to reflect the new billable event by adding the updated total billed amount value associated with the original billing schedule record 204 ($9000) to the total billed amount value associated with the amendment billing schedule record 206 ($2500) to obtain an updated total billed amount associated with the billing group record 202 of $11500 (e.g., task 310). Depending on the invoice configuration metadata 140, the amendment billable event and the original schedule billable event may be combined or otherwise incorporated at a common invoice record 220 to bill the customer or account for both billable events at the same time, with the amendment billable event (e.g., $500 on Sep. 1, 2022) and the original schedule billable event (e.g., $1000 on Sep. 15, 2022) being associated with separate line items on the common invoice. That said, in other implementations, the amendment billable event may result in generation of an invoice record 220 that is separate from the invoice record 220 generated in response to the original schedule billable event to invoice the customer or account under the amendment billing schedule separately from the original billing schedule.

By virtue of the tiered hierarchical arrangement 200 of records and the record management process 300, the billing group record 202 maintains an accurate and up-to-date accounting of the total amount billed to a particular customer or account in association with a particular order or subscription, while allowing any number of different amendments during the lifecycle of the original order or subscription to vary the quantity, price, time and/or frequency of billable events associated with the order or subscription in a flexible and user-configurable manner that may be independent of, and asynchronous to, the original billing schedule associated with that order or subscription. At the same time, the child billing schedule records 204, 206 and grandchild billing period transaction records 208, 210 preserve auditability and accounting of individual billable events and accommodate flexible and user-configurable invoicing of the amendments to the original order or subscription, individually or in combination with the billable events associated with the original billing schedule.

For example, the subject matter described herein supports complex billing strategies or modifications like a reduction or downgrade to an existing evergreen subscription. To implement a reduction order (e.g., an order for a negative quantity or price), the billing service creates a child billing schedule record for a negative quantity or price that results in its own corresponding child billing period transaction records to effectively subtract or refund the customer or account associated with the original existing evergreen subscription on the desired periodic basis to effectuate the reduction while preserving the original billing group and original billing schedule records to maintain accounting and auditability of the original subscription. In this regard, the reductions may be billed asynchronously to and independent of the billing period transactions associated with the original billing schedule while offsetting the total billed amount associated with the original billing group record by virtue of the record management process 300. Moreover, billing period transactions associated with the reduction order may be combined with the original billing period transactions when invoices are generated to invoice the customer or account in a manner that reflects the reduction without requiring modification to the original billing schedule or the original billing group record.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

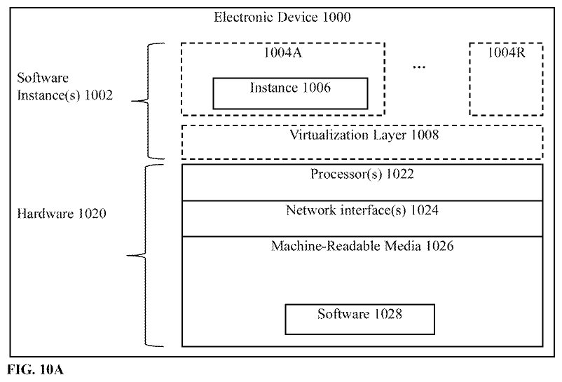

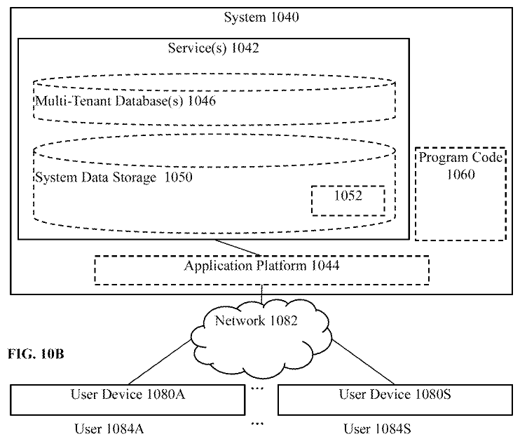

FIG. 10A is a block diagram illustrating an electronic device 1000 according to some example implementations. FIG. 10A includes hardware 1020 comprising a set of one or more processor(s) 1022, a set of one or more network interfaces 1024 (wireless and/or wired), and machine-readable media 1026 having stored therein software 1028 (which includes instructions executable by the set of one or more processor(s) 1022). The machine-readable media 1026 may include non-transitory and/or transitory machine-readable media. Each of the previously described clients and a billing service may be implemented in one or more electronic devices 1000. In one implementation: 1) each of the clients is implemented in a separate one of the electronic devices 1000 (e.g., in end user devices where the software 1028 represents the software to implement clients to interface directly and/or indirectly with the billing service (e.g., software 1028 represents a web browser, a native client, a portal, a command-line interface, and/or an application programming interface (API) based upon protocols such as Simple Object Access Protocol (SOAP), Representational State Transfer (REST), etc.)); 2) the billing service is implemented in a separate set of one or more of the electronic devices 1000 (e.g., a set of one or more server devices where the software 1028 represents the software to implement the billing service); and 3) in operation, the electronic devices implementing the clients and the billing service would be communicatively coupled (e.g., by a network) and would establish between them (or through one or more other layers and/or or other services) connections for submitting requests to the billing service. Other configurations of electronic devices may be used in other implementations (e.g., an implementation in which the client and the billing service are implemented on a single one of electronic device 1000).

During operation, an instance of the software 1028 (illustrated as instance 1006 and referred to as a software instance; and in the more specific case of an application, as an application instance) is executed. In electronic devices that use compute virtualization, the set of one or more processor(s) 1022 typically execute software to instantiate a virtualization layer 1008 and one or more software container(s) 1004A-1004R (e.g., with operating system-level virtualization, the virtualization layer 1008 may represent a container engine (such as Docker Engine by Docker, Inc. or rkt in Container Linux by Red Hat, Inc.) running on top of (or integrated into) an operating system, and it allows for the creation of multiple software containers 1004A-1004R (representing separate user space instances and also called virtualization engines, virtual private servers, or jails) that may each be used to execute a set of one or more applications; with full virtualization, the virtualization layer 1008 represents a hypervisor (sometimes referred to as a virtual machine monitor (VMM)) or a hypervisor executing on top of a host operating system, and the software containers 1004A-1004R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1028 is executed within the software container 1004A on the virtualization layer 1008. In electronic devices where compute virtualization is not used, the instance 1006 on top of a host operating system is executed on the “bare metal” electronic device 1000. The instantiation of the instance 1006, as well as the virtualization layer 1008 and software containers 1004A-1004R if implemented, are collectively referred to as software instance(s) 1002.

Alternative implementations of an electronic device may have numerous variations from that described above. For example, customized hardware and/or accelerators might also be used in an electronic device.

FIG. 10B is a block diagram of a deployment environment according to some example implementations. A system 1040 includes hardware (e.g., a set of one or more server devices) and software to provide service(s) 1042, including a billing service. In some implementations the system 1040 is in one or more datacenter(s). These datacenter(s) may be: 1) first party datacenter(s), which are datacenter(s) owned and/or operated by the same entity that provides and/or operates some or all of the software that provides the service(s) 1042; and/or 2) third-party datacenter(s), which are datacenter(s) owned and/or operated by one or more different entities than the entity that provides the service(s) 1042 (e.g., the different entities may host some or all of the software provided and/or operated by the entity that provides the service(s) 1042). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 1040 is coupled to user devices 1080A-1080S over a network 1082. The service(s) 1042 may be on-demand services that are made available to one or more of the users 1084A-1084S working for one or more entities other than the entity which owns and/or operates the on-demand services (those users sometimes referred to as outside users) so that those entities need not be concerned with building and/or maintaining a system, but instead may make use of the service(s) 1042 when needed (e.g., when needed by the users 1084A-1084S). The service(s) 1042 may communicate with each other and/or with one or more of the user devices 1080A-1080S via one or more APIs (e.g., a REST API). In some implementations, the user devices 1080A-1080S are operated by users 1084A-1084S, and each may be operated as a client device and/or a server device. In some implementations, one or more of the user devices 1080A-1080S are separate ones of the electronic device 1000 or include one or more features of the electronic device 1000.

In some implementations, the system 1040 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 1040 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 1040 may include an application platform 1044 that enables PAAS for creating, managing, and executing one or more applications developed by the provider of the application platform 1044, users accessing the system 1040 via one or more of user devices 1080A-1080S, or third-party application developers accessing the system 1040 via one or more of user devices 1080A-1080S.

In some implementations, one or more of the service(s) 1042 may use one or more multi-tenant databases 1046, as well as system data storage 1050 for system data 1052 accessible to system 1040. In certain implementations, the system 1040 includes a set of one or more servers that are running on server electronic devices and that are configured to handle requests for any authorized user associated with any tenant (there is no server affinity for a user and/or tenant to a specific server). The user devices 1080A-1080S communicate with the server(s) of system 1040 to request and update tenant-level data and system-level data hosted by system 1040, and in response the system 1040 (e.g., one or more servers in system 1040) automatically may generate one or more Structured Query Language (SQL) statements (e.g., one or more SQL queries) that are designed to access the desired information from the multi-tenant database(s) 1046 and/or system data storage 1050.

In some implementations, the service(s) 1042 are implemented using virtual applications dynamically created at run time responsive to queries from the user devices 1080A-1080S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1060 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1044 includes an application setup mechanism that supports application developers' creation and management of applications, which may be saved as metadata by save routines. Invocations to such applications, including the billing service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1082 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1040 and the user devices 1080A-1080S.

Each user device 1080A-1080S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1040. For example, the user interface device can be used to access data and applications hosted by system 1040, and to perform searches on stored data, and otherwise allow one or more of users 1084A-1084S to interact with various GUI pages that may be presented to the one or more of users 1084A-1084S. User devices 1080A-1080S might communicate with system 1040 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 1080A-1080S might include an HTTP client, commonly referred to as a “browser,” for sending and receiving HTTP messages to and from server(s) of system 1040, thus allowing users 1084A-1084S of the user devices 1080A-1080S to access, process and view information, pages and applications available to it from system 1040 over network 1082.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method comprising:
automatically generating, at a database system, a child record having a field value based on configuration data associated with a parent record at a time based on the configuration data associated with the parent record;
automatically updating, at the database system, a second field value for a summarization field associated with the parent record in response to automatically generating the child record; and
after automatically updating the second field value:
identifying, at the database system, a group record that is a parent of the parent record based on a second field of the parent record, wherein the group record is a parent of a plurality of records including the parent record;
automatically updating, at the database system, a third value for a second summarization field associated with the group record based at least in part on the second field value; and
providing, by the database system, a graphical representation of the group record comprising a graphical representation of the third value for the second summarization field.

2. The method of claim 1, wherein providing the graphical representation of the group record comprises providing, within an instance of a virtual application presented at a client device coupled to the database system over a network, a group record graphical user interface (GUI) display including the graphical representation of the third value for the second summarization field.

3. The method of claim 2, further comprising providing a second GUI display including a graphical representation of the second field value for the summarization field associated with the parent record in response to selection of a GUI element on the group record GUI display, wherein the GUI element is associated with the parent record.

4. The method of claim 3, further comprising providing a third GUI display including a graphical representation of the field value associated with the child record in response to selection of a second GUI element on the second GUI display, wherein the second GUI element is associated with the child record.

5. The method of claim 1, further comprising:
automatically generating, at the database system, a second child record having a third field value based on second configuration data associated with a second parent record of the plurality of records at a second time based on the second configuration data associated with the second parent record;
automatically updating, at the database system, a fourth field value for the summarization field associated with the second parent record to reflect the third field value in response to automatically generating the second child record; and
after automatically updating the fourth field value:
identifying, at the database system, the group record as a parent of the second parent record based on a third field of the second parent record;
automatically updating, at the database system, the third value for the second summarization field associated with the group record to an updated value based at least in part on the fourth field value; and
providing, by the database system, the graphical representation of the group record comprising a graphical representation of the updated value for the second summarization field.

6. The method of claim 5, wherein the second time associated with generation of the second child record is asynchronous to and independent of the time associated with generation of the child record.

7. The method of claim 5, wherein the second summarization field comprises a cumulative total of the summarization field of the plurality of records.

8. The method of claim 1, further comprising:
automatically generating, at the database system, a second child record having the field value based on the configuration data associated with the parent record at a second time based on the configuration data associated with the parent record;
automatically updating, at the database system, the summarization field associated with the parent record to an updated value that reflects the field value of the second child record in response to automatically generating the second child record; and
after automatically updating the summarization field:
automatically updating, at the database system, the second summarization field associated with the group record based at least in part on the updated value for the summarization field resulting in a second updated value for the second summarization field of the group record; and
providing, by the database system, the graphical representation of the group record comprising a graphical representation of the second updated value for the second summarization field.

9. The method of claim 1, further comprising automatically generating, at the database system, an invoice record based at least in part on the field value of the child record in accordance with invoice configuration metadata maintained at the database system.

10. At least one non-transitory machine-readable storage medium that provides instructions that, when executed by at least one processor, are configurable to cause the at least one processor to perform operations comprising:
automatically generating, at a database system, a child record having a field value based on configuration data associated with a parent record at a time based on the configuration data associated with the parent record;
automatically updating, at the database system, a second field value for a summarization field associated with the parent record in response to automatically generating the child record; and
after automatically updating the second field value:
identifying, at the database system, a group record that is a parent of the parent record based on a second field of the parent record, wherein the group record is a parent of a plurality of records including the parent record; and
automatically updating, at the database system, a third value for a second summarization field associated with the group record based at least in part on the second field value; and
providing, within an instance of a virtual application presented at a client device coupled to a network, a group record graphical user interface (GUI) display including a graphical representation of the group record comprising a graphical representation of the third value for the second summarization field.

11. The at least one non-transitory machine-readable storage medium of claim 10, wherein the instructions are configurable to cause the at least one processor to provide, within the instance of the virtual application, a second GUI display including a graphical representation of the second field value for the summarization field associated with the parent record in response to selection of a GUI element on the group record GUI display, wherein the GUI element is associated with the parent record.

12. The at least one non-transitory machine-readable storage medium of claim 11, wherein the instructions are configurable to cause the at least one processor to provide, within the instance of the virtual application, a third GUI display including a graphical representation of the field value associated with the child record in response to selection of a second GUI element on the second GUI display, wherein the second GUI element is associated with the child record.

13. The at least one non-transitory machine-readable storage medium of claim 11, wherein the child record comprises a billing transaction period record and the parent record comprises a billing schedule record.

14. The at least one non-transitory machine-readable storage medium of claim 13, wherein the plurality of records comprise a plurality of billing schedule records.

15. The at least one non-transitory machine-readable storage medium of claim 14, wherein the second summarization field comprises a cumulative total of the summarization field of the plurality of billing schedule records.

16. The at least one non-transitory machine-readable storage medium of claim 15, wherein the summarization field comprises a total amount billed associated with a respective billing schedule record of the plurality of billing schedule records.

17. A computing device comprising:
at least one non-transitory machine-readable storage medium that stores software; and
at least one processor, coupled to the at least one non-transitory machine-readable storage medium, to execute the software that implements a billing service and that is configurable to:
automatically generate a child record having a field value based on configuration data associated with a parent record at a time based on the configuration data associated with the parent record;
automatically update a second field value for a summarization field associated with the parent record in response to automatically generating the child record; and
after automatically updating the second field value:
identify a group record that is a parent of the parent record based on a second field of the parent record, wherein the group record is a parent of a plurality of records including the parent record; and
automatically update a third value for a second summarization field associated with the group record based at least in part on the second field value; and
provide, within an instance of a virtual application presented at a client device coupled to a network, a group record graphical user interface (GUI) display including a graphical representation of the group record comprising a graphical representation of the third value for the second summarization field.

18. The computing device of claim 17, wherein the child record comprises a billing period transaction record having the field value for an amount billed field.

19. The computing device of claim 18, wherein the parent record comprises a billing schedule record and the summarization field comprises a total amount billed field associated with the billing schedule record.

20. The computing device of claim 19, wherein:
the group record comprises a billing group record;
the plurality of records comprises a plurality of billing schedule records; and
the second summarization field comprises a total amount billed field associated with the plurality of billing schedule records having a child relationship with respect to the billing group record.
